(19) United States
(12) Patent Application Publication
(10) Pub. No.: US 2014/0207620 A1
(43) Pub. Date: Jul. 24, 2014

(54) Systems and Methods for Taxonomy-Based Price Adjustments and Product Location

(71) Applicant: Dockweiler Media, Inc., Los Angeles, CA (US)

(72) Inventors: Brian Nickerson, Los Angeles, CA (US); Christian Levy, Los Angeles, CA (US); Samira Mahjoub, Los Angeles, CA (US)

(73) Assignee: Dockweiler Media, Inc., Los Angeles, CA (US)

(21) Appl. No.: 14/159,206

(22) Filed: Jan. 20, 2014

Related U.S. Application Data
(60) Provisional application No. 61/755,413, filed on Jan. 22, 2013.

(51) Int. Cl. G06Q 30/06

(52) U.S. Cl. CPC G06Q 30/0623
USPC 705/26.61

(57) ABSTRACT

Systems and methods for price adjustment location systems in accordance with embodiments of the invention are illustrated. In one embodiment, a product location system includes a processor and memory, wherein the memory is configured to store a price adjustment location application and wherein the price adjustment location application configures the processor to obtain a search query, where the search query includes product budget data identifying at least one product price threshold, determine at least one product category based on the obtained search query, where a product category describes a grouping of products, identify at least one price adjustment based on the determined at least one product category and the product budget data, where the at least one relevant price adjustment falls within a specified budget based on the at least one product price threshold, and generate a listing of relevant price adjustments based on the identified price adjustments.

### CROSS-REFERENCE TO RELATED APPLICATIONS

The current application claims priority to U.S. Provisional Patent Application Ser. No. 61/755,413, filed Jan. 22, 2013, the disclosure of which is hereby incorporated by reference in its entirety.

### FIELD OF THE INVENTION

The present invention relates to online shopping, specifically systems and methods for price adjustments for products and services.

### BACKGROUND OF THE INVENTION

The terms e-commerce and m-commerce are used to refer to the buying and selling of products or services over electronic systems (such as the Internet) using computers, mobile devices such as mobile phone handsets, and tablet computers, and/or consumer electronic devices such as game consoles, televisions, various set top boxes, and media players. The amount of trade conducted via e-commerce has grown extraordinarily with widespread Internet usage. As a result, a variety of websites have been established to offer products and services. A common configuration for such a website is to present each individual product or service on a separate landing page. Such websites also typically organize the products and/or services offered in a hierarchy and feature categories of products and/or services on separate landing pages. Many popular e-commerce websites exists, including the Amazon.com service from Amazon.com, Inc. of Seattle, Wash. and the Newegg.com service from Newegg.com, Inc. of City of Industry, Calif.

Online retailing is a form of e-commerce allowing consumers to browse and purchase products from a retailer via the Internet. Consumers browse a listing of products provided by the retailer and place those products in a virtual shopping cart, allowing the consumer to accumulate multiple items and to adjust quantities. Once the consumer has completed browsing for products, the consumer checks out by providing payment and delivery information to pay for and provide a location to deliver the selected products. The consumer often receives one or more confirmations once the checkout procedure is complete.

When shopping for products, consumers tend to browse a wide variety of products in a particular category. Consumers then select products to purchase based on a variety of factors, including, but not limited to, the price of the products, the perceived quality of the products, and the suitability of the products for the consumer's needs. At a traditional brick and mortal store, such as Best Buy from Best Buy Co., Inc. of Richfield, Minn. or Walmart from Walmart Stores, Inc. of Bentonville, Ark., consumers are able to browse a variety of products in a particular category depending on what is on the shelves in the store. A variety of e-commerce retailers, such as the Amazon.com service and the Newegg.com service, enable a similar online shopping experience by providing consumers with the ability to purchase products from a variety of manufactures. In addition, many manufacturers of products make their products available for sale directly to the consumer via their own e-commerce site. By having multiple sources of products in a particular category scattered throughout both the e-commerce landscape and in the real world, consumers face a difficult task in performing a thorough search of available products in order to find the products that best suit their needs.

Many online retailers provide the ability to apply coupons or other discounts to an order. A coupon is a document or code that enables a consumer to receive a discount or other benefit if a particular product associated with the coupon is purchased. For example, a coupon may offer a discount on a particular product or a coupon may enable a consumer to receive a bonus gift if a particular product is purchased. The coupons and other discounts are often published via sources other than a retailer's website.

### SUMMARY OF THE INVENTION

Systems and methods for price adjustment location systems in accordance with embodiments of the invention are illustrated. In one embodiment, a product location system includes a processor and memory, wherein the memory is configured to store a price adjustment location application and wherein the price adjustment location application configures the processor to obtain a search query, where the search query includes product budget data identifying at least one product price threshold, determine at least one product category based on the obtained search query, where a product category describes a grouping of products, identify at least one price adjustment based on the determined at least one product category and the product budget data, where the at least one relevant price adjustment falls within a specified budget based on the at least one product price threshold, and generate a listing of relevant price adjustments based on the identified price adjustments.

In another embodiment of the invention, the search query is obtained from a client machine and the price adjustment location application further configures the processor to transmit the generated listing of relevant price adjustments to the client machine.

In an additional embodiment of the invention, the generated listing of relevant price adjustments further includes instructions that configure the client machine to generate a page displaying the product list.

In yet another additional embodiment of the invention, the search query further includes product category data identifying at least one requested product category and determining the at least one product category is based on the product category data contained in the search query.

In still another additional embodiment of the invention, the price adjustment location application further configures the processor to determine the at least one product category based on the search query using a master taxonomy and the master taxonomy includes a set of categories, a set of products, a set of price adjustments, and a set of relationships between the categories, products, and price adjustments, where the relationships represent classifications of the products, categories, and price adjustments.

In yet still another additional embodiment of the invention, at least one category and at least one product described within the master taxonomy include at least one keyword component and the price adjustment location application further configures the processor to map keywords components into the master taxonomy, where the mapped keyword components describe the relationships between the categories and products described within the master taxonomy.

In yet another embodiment of the invention, the price adjustment location application further configures the processor to obtain a retailer taxonomy including keyword components describing the categories and products available from a retailer server system and map the obtained retailer taxonomy into the master taxonomy based on the keyword components contained within the obtained retailer taxonomy.

In still another embodiment of the invention, the price adjustment location application further configures the processor to filter the master taxonomy, where filtering the master taxonomy includes removing at least one piece of product data from the master taxonomy.

In yet still another embodiment of the invention, the price adjustment location application further configures the processor to sort the listing of price adjustments based on the relevancy of the identified price adjustments.

In yet another additional embodiment of the invention, the price adjustments include price adjustment metadata describing the click-through rate associated with the price adjustments and the price adjustment location application further configures the processor to determine the relevancy of price adjustments based on the click-through rate of the price adjustments.

In still another additional embodiment of the invention, the price adjustment location application further configures the processor to weight the relevancy of price adjustments based on the recency of the click-through rate described in the price adjustment metadata associated with the price adjustments.

In yet still another additional embodiment of the invention, the price adjustments include price adjustment metadata describing the conversion rate associated with the price adjustments and the price adjustment location application further configures the processor to determine the relevancy of price adjustments based on the conversion rate described in the price adjustment metadata.

In yet another embodiment of the invention, the search query further includes product data identifying at least one product and the price adjustment location application further configures the processor to determine at least one product category based on the product data, identify at least one piece of product data based on the determined at least one product category, where a piece of product data includes product metadata describing price data associated with the product data, determine product price data based on the identified pieces of product data and the relevant price adjustments, and generate a product list including the at least one piece of product data and the associated product price data.

In still another embodiment of the invention, the price adjustment location application further configures the processor to rank the product list based on the relevancy of the products data contained in the product list.

In yet still another embodiment of the invention, the search query includes location information and the price adjustment location application further configures the processor to identify at least one piece of product data based on the location information, where the product data includes product metadata including product location information describing the physical location of the product described by the product data, determine product price data for the at least one piece of product data, and return the determine product price data.

In yet another additional embodiment of the invention, the location information for a piece of product data includes the location of a retailer selling a product described by the piece of product data.

In still another additional embodiment of the invention, the price adjustment location application further configures the processor to identify available price adjustments that are valid for the retailer selling the product described by the piece of product data.

In yet still another additional embodiment of the invention, the price adjustment location application further configures the processor to generate a price adjustment based on the product data and the obtained search query, where the generated price adjustment is valid at a retailer located proximate to the location data.

In yet another embodiment of the invention, the search query is obtained from a consumer device and the location information in the search query describes the physical location of the consumer device captured using location-determination capabilities of the mobile device.

In still another embodiment of the invention, the price adjustment location application further configures the processor to transmit the generated listing of relevant price adjustments to a consumer device.

In yet still another embodiment of the invention, the search query further includes user profile information describing tracked user behaviors with respect to the product location system and the price adjustment location application further configures the processor to identify at least one price adjustment based on the user profile information.

Yet another embodiment of the invention includes a method for generating a list of price adjustments including obtaining a search query using a product location system, where the search query includes product budget data identifying at least one product price threshold, determining at least one product category based on the obtained search query using the product location system, identifying at least one relevant price adjustment based on the determined product category and the product budget data using the product location system, where the at least one relevant price adjustment falls within a specified budget based on the at least one product price threshold, and generating a listing of relevant price adjustments based on the identified relevant price adjustments using the product location system.

### BRIEF DESCRIPTION OF THE DRAWINGS

FIG. 1 is a network diagram of a shopping system including a price adjustment location system in accordance with an embodiment of the invention.

FIG. 2 is a conceptual illustration of a price adjustment location system in accordance with an embodiment of the invention.

FIG. 3A is a conceptual illustration of a process for collecting price adjustment data and publishing price adjustment listings in accordance with an embodiment of the invention.

FIG. 3B is a flowchart illustrating a process for associating products with a taxonomy using a price adjustment location system in accordance with an embodiment of the invention.

FIG. 4A is a flowchart illustrating a process for generating a list of price adjustments based on a target price and a category using a price adjustment location system in accordance with an embodiment of the invention.

FIG. 4B is a flowchart illustrating a process for generating a list of products based on a target price and a category using a price adjustment location system in accordance with an embodiment of the invention.

FIG. 5 is a flowchart illustrating a process for determining related categories and products using a taxonomy of categories and products maintained by a price adjustment location system in accordance with an embodiment of the invention.

FIG. 6 is a flowchart illustrating a process for computing the adjusted price for a particular product using a price adjustment location system in accordance with an embodiment of the invention.

FIG. 7 is a flowchart illustrating a process for obtaining location based price adjustments for products using a price adjustment location system in accordance with an embodiment of the invention.

### DETAILED DISCLOSURE OF THE INVENTION

Turning now to the drawings, price adjustment location systems in accordance with embodiments of the invention are illustrated. A price adjustment can be considered to include any offer provided by a manufacturer and/or retailer that modifies the standard terms on which particular goods and/or services are offered for sale. Price adjustments include, but are not limited to, offers such as free shipping, coupons for a particular product, and bonus items bundled with the purchase of a particular product. Consumers searching for a price adjustment for a particular product are typically forced to search a large variety of sources to determine if any price adjustments are available. Therefore, comparison price shopping can involve visiting multiple retailer websites to obtain pricing information and multiple coupon sites to determine whether any discounts are available. In addition, consumers may then be required to test each price adjustment to determine if it is still being honored by (e.g. is still valid with) a particular retailer. Consumers can utilize a price adjustment location system in accordance with embodiments of the invention to efficiently search a variety of manufactures, and/or retailers to locate price adjustments for products that suit their needs.

Price adjustment location systems in accordance with many embodiments of the invention are configured to gather data concerning price adjustments from various sources and to associate the data with a taxonomy of categories and products. Using the taxonomy, a price adjustment location system can locate relevant price adjustment data in response to queries for price adjustments with respect to one or more products or categories. In many embodiments, the price adjustment location system is configured to retrieve specific products offered by retailers based on factors including, but not limited to, the price of the product and the price adjustments available with respect to the product. In a number of embodiments, the price adjustment location system is configured to improve the relevancy of the price adjustments presented to a user based on information collected by the price adjustment location system concerning usage of specific price adjustments. In addition, price adjustment location systems can build profiles of specific users and/or groups of users that can be utilized to present price adjustments and/or products from retailers and/or brands preferred by a particular user or type/demographic of user.

In a number of embodiments, price adjustment location systems obtain price adjustment data (i.e. data describing a price adjustment) from a variety of sources and associate price adjustment metadata with the price adjustment data. In many embodiments, the price adjustment metadata is used to improve the ability of the price adjustment location system to match relevant price adjustment data to queries. Price adjustment data can include digital codes or other data, such as, but not limited to, effective dates, URLs, and/or product stock-keeping units (SKUs), that enable a price adjustment to be presented to and honored by a retailer. Other price adjustments and price adjustment data can be utilized as appropriate to the requirements of specific applications in accordance with embodiments of the invention. The price adjustment metadata that is associated with the price adjustment data by the price adjustment location system can include a variety of information, such as, but not limited to, the start date for the price adjustment, the end date for the price adjustment, the retailers who will honor the price adjustment, the location of the price adjustment, and/or the provider of the price adjustment. Any of a variety of metadata that can facilitate matching of relevant price adjustment data to search queries can be associated with price adjustment data by price adjustment location systems as appropriate to the requirements of specific applications in accordance with embodiments of the invention.

In several embodiments, price adjustment location systems utilize taxonomies to categorize and search for price adjustments in response to a query. The term taxonomy is used to describe a particular scheme for classifying products and/or services. In many embodiments, the products and/or services offered by a particular manufacturer or retailer are mapped into the taxonomy. In this way, the taxonomy can be used to locate all retailers that offer a particular category and/or that sell a specific product. The price adjustment location system can also map individual price adjustments to the categories and/or products within the taxonomy to which they apply based on the manufacturer and/or retailer offering the price adjustment. In a variety of embodiments, the mapping of price adjustments can be made to specific categories and/or product restrictions placed upon the price adjustment by the manufacturer and/or retailer. In addition, the price adjustment location system can map keyword components to the categories and products within the taxonomy and these relationships can be utilized to identify potentially relevant relationships between retailers, categories, products, and/or price adjustments using the taxonomy. In many embodiments, the taxonomy is hierarchical and involves multiple levels of categories that can describe individual products. In a number of embodiments, products within the hierarchy are further identified by the SKUs of specific retailers that offer the product. The price adjustment location system can generate its own local (or master) taxonomy to classify products and price adjustments, retrieve a taxonomy from a retailer server system, or combine the local taxonomy with one or more retrieved taxonomies. In several embodiments, retrieved taxonomies can include relevant relationships such as, but not limited to, relationships between keyword components and specific categories and/or products within the taxonomy. As can readily be appreciated, the specific structure of the taxonomy utilized in a price adjustment location system in accordance with embodiments of the invention typically depends upon the requirements of a specific application.

Price adjustment location systems in accordance with many embodiments of the invention are configured to present relevant price adjustments based on a received search query. The search query can include a variety of information, including, but not limited to, a category of products, a specific product(s), and/or a price target for the products. Other parameters can be included in a query in accordance with requirements of specific applications, such as quantities of a product, product names, product attributes, retailers, and locations. In many embodiments, the price adjustment location system receives queries that identify a category and a budget and the price adjustment location system can utilize the taxonomy to identify price adjustments from specific manufacturers and/or retailers that are relevant to the category at the specified budget. In a number of embodiments, the query can identify a product and the price adjustment location system can utilize the taxonomy to identify price adjustments relevant to the product from specific manufacturers and/or retailers. In addition, the price adjustment location system can determine the retailer from which the product can be purchased for the lowest cost accounting for available price adjustments. In many embodiments, the price adjustment location system receives a query from a mobile device and the price adjustment location system presents information concerning retailers from which the product can be purchased based on proximity, availability, and/or the lowest cost accounting for available price adjustments.

In several embodiments, the usage of price adjustments is utilized by the price adjustment location system to improve the relevancy of the price adjustments presented to users in response to search queries. Price adjustment location systems can track the usage of price adjustments and can improve the relevancy of the price adjustments presented to users in response to queries based on a variety of factors, including, but not limited to, the click-through rate for a particular price adjustment and/or the conversion rate of a particular price adjustment. The term conversion is used here to describe when a selected price adjustment located for a user by a price adjustment location system is utilized during the purchase of a product; the conversion can apply to the purchased product and/or any price adjustments applied to the purchased product. As can readily be appreciated, any of a variety of additional and/or alternative criteria can be utilized to optimize the relevancy of price adjustments presented to a user in response to a search query by a price adjustment location system as appropriate to the requirements of a specific application in accordance with embodiments of the invention.

In a number of embodiments, price adjustment location systems are configured to create user profiles associated with a specific consumer, groups of consumers, and/or demographic of consumers. Product location systems can utilize the user profiles to track a consumer's usage of the price adjustment location system, including search queries received, products viewed, price adjustments utilized, products purchased, the retailers at which the consumer shops, and/or the location of the consumer. Other user behaviors and attributes can be tracked in a user profile in accordance with the requirements of a variety of embodiments of the invention. In many embodiments, user profile information is utilized by the price adjustment location system to optimize price adjustment listings and/or product listings.

Many third-party services can be utilized by consumers to request and consume product listings generated by price adjustment location systems. In a variety of embodiments, user profiles and/or consumer device are associated with a third party service. These third party services include, but are not limited to, online social networks such as the Google+ service provided by Google, Inc. of Mountain View, Calif. and the Facebook service provided by Facebook, Inc. of Menlo Park, Calif., search engines such as the Bing service provided by Microsoft Corporation of Redmond, Wash., content hosting platforms such as the YouTube service provided by Google, Inc., blogging platforms such as sites running the Movable Type platform provided by Six Apart of San Francisco, Calif., and any other platform provided by a party separate from the price adjustment location system. Additionally, retailers and/or manufacturers can utilize the information provided by the price adjustment location system. In this way, the price adjustment location system can utilize activity information associated with the user profile in the generation of price adjustment and/or product listings. In a number of embodiments, the activity information is taken based on user interactions with the third-party service. This allows the price adjustment location system to target price adjustment and/or product listings to user activity taken outside of the price adjustment location system and distribute those price adjustment and/or product listings to a network of third-party services associated with the price adjustment location system. The third party services can then display the price adjustment and/or product listing alongside the regular content of the third party service, thereby providing the price adjustment and/or product listing content to the audience engaged with the third party content.

Although the present invention is frequently described with respect to products sold by a retailer, price adjustment location systems can be utilized to locate products and/or services provided by retailers, service providers, and/or manufacturers in accordance with the requirements of embodiments of the invention. Price adjustment location systems and methods for retrieving relevant price adjustments in response to user queries in accordance with embodiments of the invention are discussed further below.

### System Overview

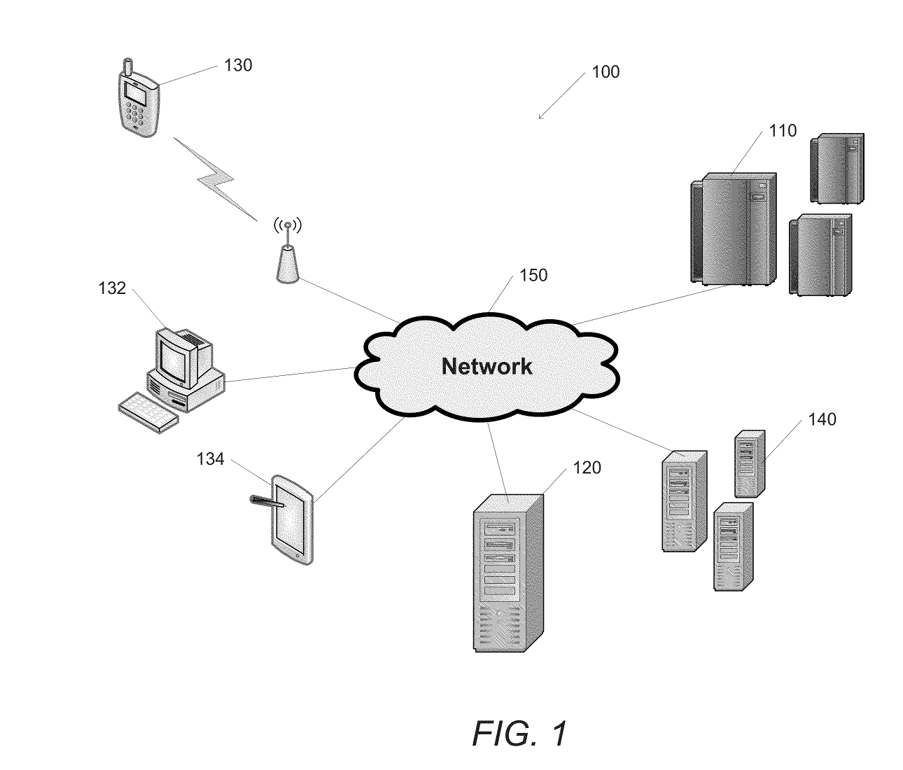

A shopping system including a price adjustment location system in accordance with an embodiment of the invention is illustrated in FIG. 1. The shopping system 100 includes a price adjustment location system 120, one or more retailer server systems 110, one or more product information server systems 140, and a plurality of consumer devices, including mobile devices 130, personal computers 132, and tablet devices 134 connected via a network 150. In a number of embodiments, the network 150 is the Internet. In many embodiments, the price adjustment location system 120 is directly connected to one or more of the retailer server systems 110 and/or one or more of the product information server systems 140.

The retailer server systems 110 are configured to provide a listing of products available for purchase via the retailer server systems and product metadata describing the attributes of one or more of the available products. In many embodiments, each product available is associated with a SKU. In several embodiments, the SKUs are not unique across retailers. The product information server systems 140 are configured to provide a plurality of price adjustments. In a variety of embodiments, the price adjustments are associated with the retailer server systems 110 and/or the products offered via the retailer server systems 110. In several embodiments, the retailer server systems 110 are configured to provide price adjustments. In a number of embodiments, the retailer server systems 110 and the product information server systems 140 are a unified system. Although the term retailer is used herein, the term retailer should be understood as encompassing manufacturers, retailers, and/or any other entity that offers products and/or services for sale. In many embodiments, the product information server systems 140 provide one or more taxonomies describing the categorization of the products available for purchase via one or more retailer server systems 110. In a variety of embodiments, at least one retailer server system 110 is configured to provide a taxonomy describing the categorization of the products available from the retailer server system 110.

The price adjustment location system 120 is configured to retrieve listings of products and/or price adjustments available from one or more of the retailer server systems 110. The price adjustment location system 120 associates product metadata with the retrieved products; the product metadata includes, but is not limited to, the retailer providing the retrieved product, the price of the retrieved product, and the SKU of the retrieved product. In order to track the products produced by manufacturers and stocked by retailers, manufacturers and retailers associate a unique SKU to each type of product and/or service stocked and/or sold by the manufacturer and/or retailer. By utilizing a unique SKU to track each type of product and/or service, a manufacturer and/or retailer can easily track inventory and sales levels utilizing automated systems. Typically, SKUs are specific to a particular entity; that is, each retailer has their own set of SKUs and a SKU identifying a first product from a first retailer can identify a second, unrelated product from a second retailer.

In a variety of embodiments, the price adjustment location system 120 contains one or more taxonomies; the price adjustment location system 120 utilizes the taxonomies to categorize the retrieved products. In several embodiments, the price adjustment location system 120 is configured to retrieve one or more taxonomies from the retailer server systems 110 and/or the product information server systems 140. In a number of embodiments, the price adjustment location system 120 is configured to combine a locally-stored taxonomy with a retrieved taxonomy to create a unified (e.g. master) taxonomy for categorizing the retrieved products.

The price adjustment location system 120 is also configured to retrieve one or more price adjustments from the product information server systems 140 or from other sources where a manufacturer and/or retailer may publish price adjustments. In a number of embodiments, the price adjustment location system retrieves price adjustment data and associates additional price adjustment metadata to the retrieved price adjustment data. Typically the price adjustment metadata is added to improve the ability of the price adjustment location system 120 to retrieve price adjustment data relevant to a specific query and can include, but is not limited to, the categories and/or products to which the price adjustment applies, the value of the price adjustment, and/or the retailer or retailers which will honor the price adjustment. The specific information added as price adjustment metadata typically depends upon the requirements of a specific application.

In many embodiments, the price adjustment location system 120 is configured to calculate product price metadata with respect to at least one product in product data retrieved from a product information server system 140. The product price metadata can include a variety of factors, including, but not limited to, the price associated with the product, any sales or other taxes to be associated with the product and/or the retailer providing the product, any price adjustments applicable to the product, and shipping and handling costs. Other factors not specifically listed can be incorporated into the product price metadata in accordance with embodiments of the invention as appropriate to the requirements of specific applications.

In a number of embodiments, the price adjustment location system 120 enables the modification of retrieved price adjustments and/or associated price adjustment metadata by a user with administrator privileges. A variety of modifications may be performed, such as editing the price adjustment, publishing the price adjustment, and rejecting the price adjustment. In several embodiments, the price adjustment location system 120 is configured to generate a listing of price adjustments retrieved in the price adjustment location system 120, including any associated price adjustment metadata.

In the illustrated embodiment, the consumer devices are configured to provide search requests to the product identification system 120 that is configured to receive such search requests. Search requests can contain a variety of search parameters, including, but not limited to, at least one category of products to search for and a price threshold. Other search parameters, such as the name of a retailer, the name of a manufacturer, color information, size information, quantity information, the location of the consumer device, and/or the previous search history of a consumer device/user can be utilized in accordance with embodiments of the invention as appropriate to the requirements of specific applications. In a variety of embodiments, consumer devices are utilized that contain location-determination capabilities, such as a Global Positioning System (GPS) receiver or cellular tower triangulation technology. Other geolocation capabilities may be utilized by client devices in accordance with a variety of embodiments of the invention. Where location information is available to a consumer device, the location information can be provided as part of the search query.

The price adjustment location system 120 is configured to utilize a taxonomy and/or product metadata to locate price adjustments and/or products based on the search parameters in the search query. In several embodiments, the price adjustment location system 120 is configured to filter the located price adjustments and/or products utilizing the search parameters. Where the user is searching for price adjustments, the price adjustment location system 120 can generate a list of price adjustments offered by specific retailers and/or manufacturers sorted in order of relevancy to the search query. Where the user is searching for a specific product, the price adjustment location system 120 can be further configured to determine product price metadata for located products offered by retailers matching the query utilizing the product metadata associated with the located products and any available price adjustments for the located products. The price adjustment location system 120 can then generate a listing of products in response to the query sorted by relevancy factors including the price of the product accounting for price adjustments offered by manufacturers and/or retailers that apply to the product. In several embodiments, the price adjustment location system 120 generates product listings including the product metadata and the product price metadata. In a variety of embodiments, the price adjustment location system 120 is configured to perform optimizations to the price adjustment and/or product listings in order to improve performance. The price adjustment location system 120 is configured to transmit the listings to the consumer devices; the consumer devices are configured to display the price adjustment listing and/or the product listing. When a price adjustment selection and/or a product selection are made from the received listings, the consumer devices transmit the selection to the price adjustment location system 120. The price adjustment location system 120 is configured to receive product selections and/or price adjustment selections and can utilize received selections to forward the client machines to the retailer server system 110 providing the selected price adjustment and/or product so that the consumer device can complete the purchase of the relevant product. In a variety of embodiments, the price adjustment location system 120 utilizes received product selections to record and aggregate data related to the selected products, selected price adjustments, and/or the actions taken by the consumer devices, including if the consumer device completes a purchase of the relevant product from the retailer server systems 110. In many embodiments, the price adjustment location system 120 utilizes this information to optimize the relevancy of future listings. In a number of embodiments, the price adjustment location system 120 determines relevancy based on a relevancy function that considers (but is not limited to) the price adjusted price of a product following application of the price adjustment, the reputation of the retailer, and/or the success of users in converting the price adjustment offer. Additional factors that can be utilized to determine relevancy of a particular offer are discussed further below.

Although a specific architecture for a shopping system including a price adjustment location system in accordance with an embodiment of the invention is conceptually illustrated in FIG. 1, any of a variety of architectures appropriate to the requirements of a specific application can be utilized in accordance with embodiments of the invention. Systems and methods for price adjustment location systems in accordance with embodiments of the invention are discussed further below

### Price Adjustment Location Systems

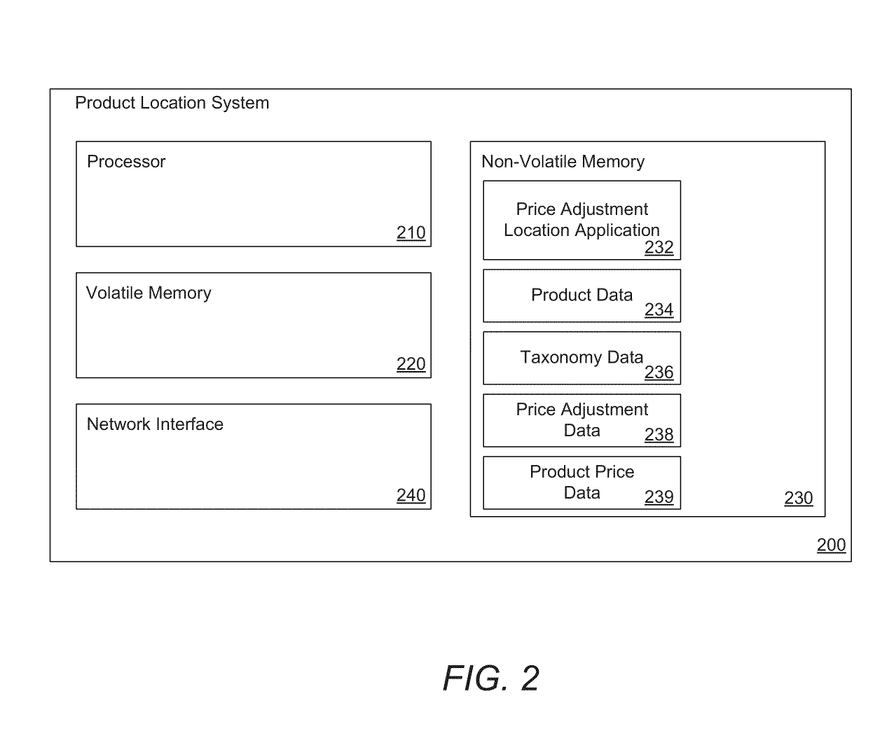

Price adjustment location systems in accordance with embodiments of the invention are configured to build databases of products, taxonomies categorizing the products, and price adjustments that can be applied to the products from retailer server systems and product information server systems. Price adjustment location systems are further configured to receive a search query, determine relevant price adjustments and/or the total cost of one or more products, and return a listing of price adjustments and/or products fulfilling the search query terms. A price adjustment location system in accordance with an embodiment of the invention is conceptually illustrated in FIG. 2. The price adjustment location system 200 includes a processor 210 in communication with volatile memory 220 and non-volatile memory 230. The price adjustment location system 200 also includes a network interface 240 configured to send and receive data over a network connection. In a number of embodiments, the network interface 240 is in communication with the processor 210, the non-volatile memory 230, and the volatile memory 220.

In several embodiments, non-volatile memory is any form of non-volatile storage configured to store a variety of data, including, but not limited to, product data 234, taxonomy data 236, price adjustment data 238, and product price data 239. In the illustrated embodiment, the non-volatile memory 230 is also configured to store a price adjustment location application 232 that configures the processor 210 to perform price adjustment location processes. In many embodiments, price adjustment location processes include: retrieving product information from remote servers to create product data 234; creating taxonomy data 236; retrieving taxonomy information from remote servers to create taxonomy data 236; retrieving price adjustment information to create price adjustment data 238; determining product price data 239; receiving search queries; generating price adjustment listings and/or product listings including one or more pieces of relevant product data 234, price adjustment data 238, and/or product price data 239; and optimizing the processes for determining relevancy of product data 234, price adjustment data 238, and/or product price data 239. In a variety of embodiments, the product price data 239 is determined using the product data 234 and the price adjustment data 238. In several embodiments, the taxonomy data 236 is utilized to categorize the product data 234 and/or the price adjustment data 238. A number of price adjustment location processes not specifically described above may be utilized as appropriate to the requirements of specific applications in accordance with embodiments of the invention.

In a number of embodiments, the processor 210 is configured to optimize price adjustment listings and/or product listings utilizing Bayesian statistics determined utilizing a click-through rate, a conversion rate, or other statistics related to overall performance across all product listings, a specific category in the taxonomy, and/or one or more merchants (i.e. manufacturer or retailer). A variety of methods for optimizing listings in accordance with embodiments of the invention are discussed below.

In many embodiments, product data 234, taxonomy data 236, and/or the price adjustment data 238 are stored using an external server system and received by the price adjustment location system 200 using the network interface 240. External server systems in accordance with a variety of embodiments include, but are not limited to, retailer server systems and product information server systems. In a variety of embodiments, the price adjustment location system 200 is configured to receive product data 234 and/or price adjustment data 238 via the network interface 240 depending on location information; the location information may be received using the network interface 240. In several embodiments, the processor 210 is configured to transmit product data 234 and/or product price data 239 using the network interface 240.

Although a specific architecture for a price adjustment location system in accordance with an embodiment of the invention is conceptually illustrated in FIG. 2, any of a variety of architectures, including those which store data or applications on disk or some other form of storage and are loaded into volatile memory 220 at runtime, and or systems that are distributed across multiple physical servers, can also be utilized. Methods for locating products in accordance with embodiments of the invention are discussed further below.

### Retrieving Price Adjustment Data

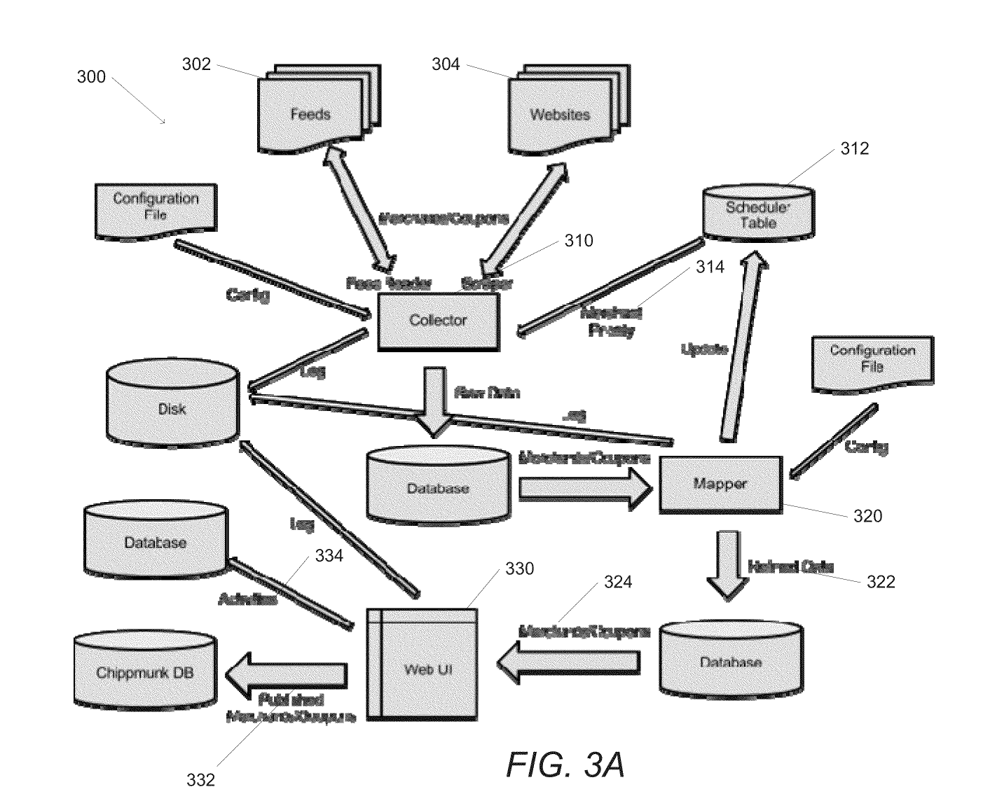

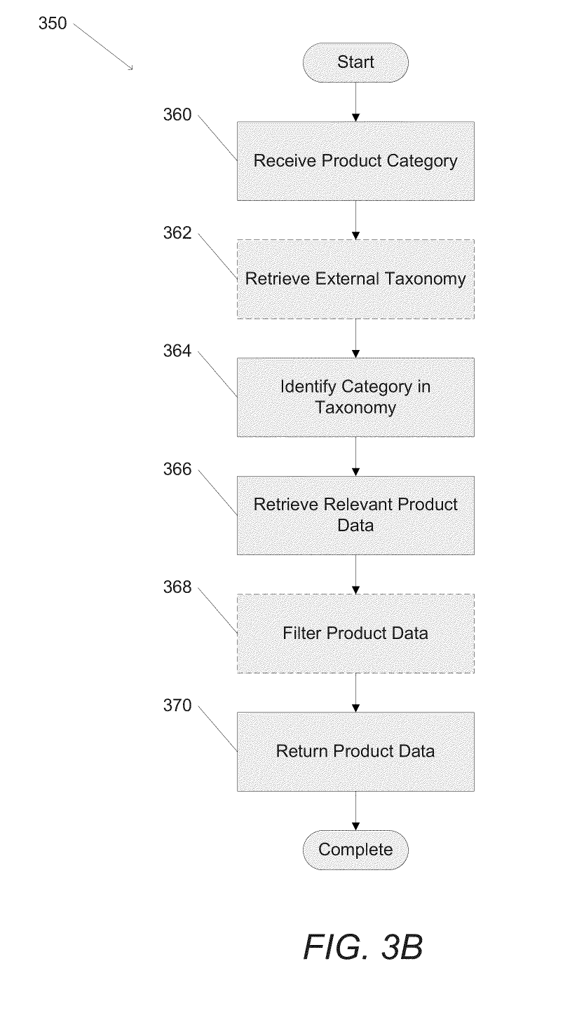

When searching for a product, consumers often want to minimize the cost of purchasing the product. Price adjustments are often offered by retailers in order to entice customers to purchase a particular product from that retailer. By locating relevant coupons, consumers can often purchase a product from a retailer advertising the product at a higher price for less than the retailer advertising the product for a lower price. Price adjustment location systems in accordance with embodiments of the invention are configured to locate price adjustments offered by a variety of retailers and/or manufacturers from a variety of sources. As discussed above, the price adjustments can be related to categories and products via a taxonomy and the taxonomy used to return relevant price adjustments in response to a received search query. A flow diagram conceptually illustrating a process for obtaining price adjustment data in accordance with an embodiment of the invention is shown in FIG. 3A. The process 300 includes collecting (310) price adjustment data. Price adjustment data is mapped (320) to the taxonomy and price adjustment data is edited (330) and published (332) for use by the price adjustment location system.

In a variety of the embodiments, collecting (310) price adjustment data includes scraping price adjustment data from price adjustment data sources including, but not limited to, price adjustment feeds 302 and websites 304 containing price adjustment data. Price adjustment data includes, but is not limited to, digital codes that can be redeemed via a retailer server system. In several embodiments, mapping (320) price adjustment data includes associating price adjustment data with price adjustment data sources. In a number of embodiments, mapping (320) price adjustment data includes associating a price adjustment schedule with price adjustment data. Price adjustment schedules in accordance with embodiments of the invention can include, but are not limited to, the start date of the price adjustment and the end date of the price adjustment. In many embodiments, the mapped (320) price adjustment data is stored with associated price adjustment metadata. In a variety of embodiments, the price adjustment metadata is utilized to determine from which price adjustment data sources to collect (310) data.

In several embodiments, a user interface 330 (in the illustrated embodiment a web based user interface) is provided that enables editors to edit, publish and reject coupons. The edited price adjustment data is then published (332) for use by the price adjustment location system in responding to queries. The activities performed during the process for obtaining price adjustment data are recorded (334). As is discussed further below, the process can also involve collecting additional usage data following publication of price adjustment data such as, but not limited to, the click-through rate for one or more price adjustments and the conversion rate for one or more price adjustments. Indeed, any of a variety of factors related to the published (332) price adjustments and activities related to the price adjustments can be measured (334) in accordance with many embodiments of the invention.

Although a specific process for obtaining and publishing price adjustment data in accordance with an embodiment of the invention is conceptually illustrated in FIG. 3A, any of a variety of processes can be utilized to obtain and publish price adjustment information as appropriate to the requirements of a specific application in accordance with embodiments of the invention. Methods for locating products utilizing taxonomies in accordance with embodiments of the invention are discussed further below.

Locating Products using Taxonomies

When searching for products, consumers are often interested in viewing a wide variety of products from multiple retailers. In several embodiments, price adjustment location systems gather product data from various manufacturers and/or retailers and associate the product data to a taxonomy. As retailers often have varying methodologies for categorizing their products, price adjustment location systems are further configured to reconcile varying categorization techniques between a retailer's taxonomy and a master taxonomy. A flow chart illustrating a process for gathering product data using various taxonomies provided by different manufacturers and/or retailers in accordance with an embodiment of the invention is shown in FIG. 3B. The process 350 includes receiving (360) a category within a master taxonomy. In a number of embodiments, one or more external taxonomies are retrieved (362). One or more categories corresponding to the category from the master taxonomy are identified (364) in the external taxonomies. Relevant product data is retrieved (366). In many embodiments, the product data is filtered (368). The product data is stored (370) for retrieval using the master taxonomy. In many embodiments, the master taxonomy is maintained by the price adjustment location system. In several embodiments, the price adjustment location system leverages a taxonomy maintained by another service as the master taxonomy and/or adds additional categories and/or layers to a taxonomy maintained by another service to create a master taxonomy. In several embodiments, the master taxonomy can be expanded based on a product category specified in a search query and/or a product category identified in received product data.

In several embodiments, retrieving (362) an external taxonomy includes receiving a taxonomy from one or more retailer server systems. In a number of embodiments, the external taxonomy or taxonomies are retrieved (362) from the retailer server systems selling the product associated with the received product data and/or selling products in the received (360) product category. In many embodiments, the retrieved (362) external taxonomy is received from a product information server system.

In several embodiments, identifying (364) one or more categories in the external taxonomy includes mapping the received (360) category from the master taxonomy to one or more categories within the external taxonomy. Alternatively, identifying (364) a category in the taxonomy can include mapping a category from a retrieved (362) external taxonomy to a category in the master taxonomy. In a variety of embodiments, the identified (364) category is used to retrieve (366) relevant product data. In many embodiments, relevant product data is retrieved (366) by querying the server system that provided the external taxonomy using the categories identified within the external category as corresponding to the received (360) category from the master taxonomy. In a number of embodiments, relevant product data is retrieved (366) from one or more retailer server systems and/or product information server systems.

Product data received from a retailer server can be filtered to clean up the data prior to publications with the price adjustment location system. In several embodiments, filtering (368) product data includes removing one or more pieces of product data from the retrieved (366) product data utilizing product metadata associated with the retrieved (366) pieces of product data. In a number of embodiments, publishing (370) product data includes storing the retrieved (366) product data along with any associated product metadata, price adjustment metadata, and/or product price metadata in a database, flat file, and/or any other appropriate data structure to enable rapid data retrieval.

Although specific processes for obtaining product data related to a particular category in accordance with embodiments of the invention are described above with respect to FIG. 3B, any of a variety of processes for retrieving product data related to a category can be utilized as appropriate to the requirements of a specific application in accordance with embodiments of the invention. Methods for returning relevant price adjustment data and products in response to search queries using a taxonomy constructed in accordance with embodiments of the invention are discussed further below.

Retrieving Price Adjustments using Product Categories and Price Thresholds

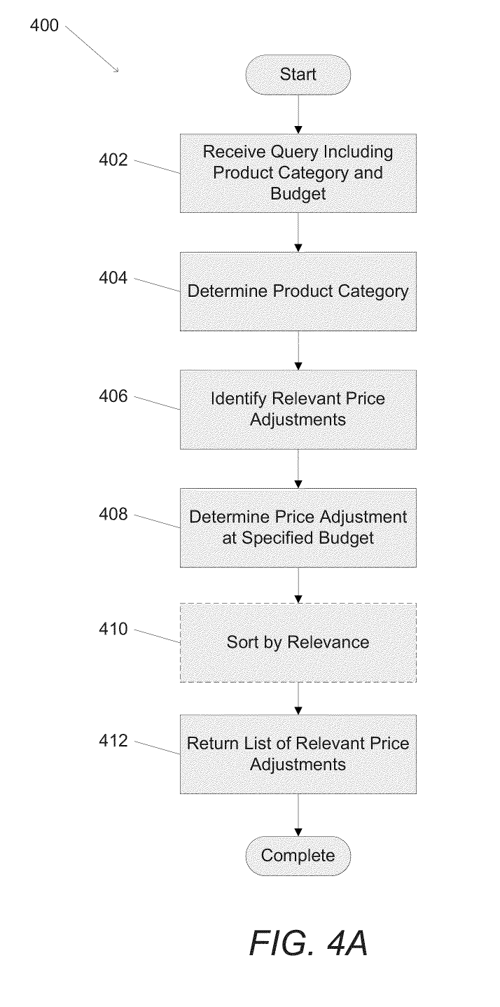

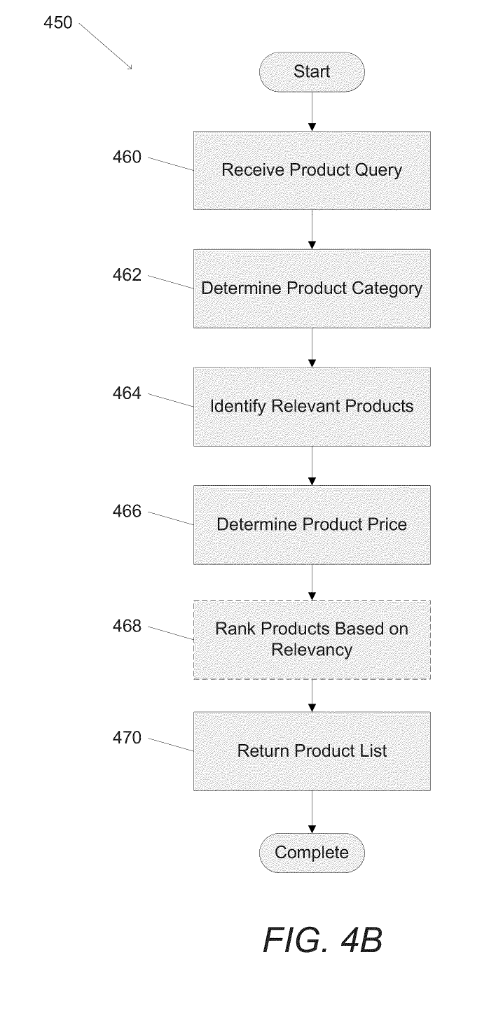

Many consumers who shop for products are not looking for a particular product; rather, consumers often shop for a particular kind of product and select a product based on how well that product fulfills the consumer's needs. In addition, many consumers have a price threshold that they will pay for a product. Price adjustment location systems in accordance with embodiments of the invention can be configured to generate a list of price adjustments that apply to a particular category and can calculate/rank the effect of the price adjustment at a particular budget. A flow chart illustrating a process for generating a list of price adjustments using a search query including a product category (e.g. product category data) and an anticipated budget (e.g. product budget data) in accordance with an embodiment of the invention is shown in FIG. 4A. The process 400 includes receiving (402) a query including a product category and an anticipated budget. A product category within the price adjustment location system's taxonomy is determined (404). In many embodiments, the product category can be determined by limiting the selections available to the user to specific categories within the taxonomy. In a number of embodiments, a search query string provided by the user is parsed and keyword components within the search query string are mapped to categories and/or products within the taxonomy to identify a product category. In certain embodiments, a user interface mechanism such as a slider is utilized to enable a user to provide an input concerning an anticipated budget amount as part of the search query. In various embodiments, price information can be obtained by parsing a search string to identify a price and/or a product from which a price can be inferred. Based on the identified category, relevant price adjustment data can be identified (406) and the price adjustment data used to determine (408) the price adjustment at a specified budget. In several embodiments, relevant price adjustments are ranked (410) based on relevance using factors including, but not limited, to the amount of the price adjustment, the reputation of the manufacturer and/or retailer offering the price adjustment, whether the manufacturer and/or retailer historically has tended to offer larger or smaller price adjustments, the performance of the price adjustment when presented in a specific location within the search results, and/or the number of different products that the retailer offers with respect to the identified category. Accordingly, the ranking (410) of price adjustments can include determining the click-through rate (CTR) of a specific price adjustment and/or the conversion rate (CV) for a specific price adjustment. The CTR and/or the CV can be determined based on products purchased using the price adjustment data to obtain a price adjustment. In this way, the ranking can be utilized to improve the likelihood that the products offered by a specific manufacturer and/or retailer are relevant to a specific search query and that price adjustments advertised by the manufacturer and/or retailer can readily be utilized when purchasing a product. The process culminates by returning (412) a list of price adjustments relevant to the search query.

Although a specific process for returning listings of relevant price adjustments based on published price adjustment data is described above with reference to FIG. 4A, a variety of processes for returning listings of relevant price adjustments based on published price adjustment data can be utilized as appropriate to the requirements of a specific application in accordance with embodiments of the invention. For example, a price adjustment location system can search for price adjustment data relevant to a specific category and budget and search for price adjustment data that would result in a larger saving at price that exceeds the specified budget. In many embodiments, a price adjustment can be listed where the price adjustment results in a saving exceeding a predetermined threshold relative to the largest price adjustment offered within the user's specified budget. Furthermore, the types of queries that can be utilized to retrieve price adjustment data are not limited to queries combining a product category and price range. Any of a variety of query parameters can be specified and an appropriately constructed taxonomy used to identify relevant price adjustments in accordance with embodiments of the invention. In addition, price adjustment location systems can return specific products and the price adjustments that apply to the products in response to a search query.

### Determining Relevancy

In several embodiments, processes for determining relevancy of price adjustments utilize a Bayesian model to determine the price adjustments to be utilized. Although the following description is stated with respect to specific price adjustments, similar processes can be employed to determine relevancy of specific products in accordance with many embodiments of the invention. The Bayesian model can be determined using the performance metrics of the query results returned across all queries, performance metrics of the query results across product queries for a particular category or categories, and/or performance metrics of the query results for one or more retailers. Other performance metrics, including performance metrics calculated using other techniques, can be utilized as appropriate to the requirements of specific applications in accordance with embodiments of the invention.

Determining relevancy using a Bayesian model utilizes aggregated statistics related to queries, the CTR for price adjustments, and the CV for price adjustments. Depending on the optimization desired, the aggregation can be over all searches, searches for a particular category, and/or searches for a particular merchant. Determining baseline performance metrics for the relevancy of price adjustments for overall performance based on the CTR in accordance with many embodiments of the invention can be determined using the following equation:

ctr₁=(ctr₀*w+clicks₁)/(w+searches₁)

where ctr₁ is the Bayesian estimate for overall CTR, ctr₀ is a prior CTR estimate, dicks/is the total click count at the time of the calculation, and searches₁ is the total search count at the time of the calculation, and w is the weight given to ctr₀.

Determining baseline performance metrics for relevancy of price adjustments for overall performance based on the CV in accordance with a variety of embodiments of the invention can be determined using the following equation:

cv₁=(cv₀*w+conversions₁)/(w+searches₁)

where cv₁ is the Bayesian estimate for overall CV, cv₀ is a prior CV estimate, conversions₁ is the total conversion count at the time of the calculation, and searches₁ and w are the same as they were for the CTR calculation above.

Determining baseline CTR metrics for category—level performance (i.e. performance with respect to queries that specify a particular category) can be determined in accordance with a number of embodiments of the invention using the following equation:

ctr₂(category)=(ctr₁*w+clicks₂(category))/(w+searches₂(category))

where ctr₂(category) is a Bayesian estimate for category-level CTR, ctr₁ was calculated above, and clicks₂(category) and searches₂(category) are the category-level clicks and searches at the time of the calculation. A Bayesian estimate for category-level CV can be determined in accordance with embodiments of the invention by:

cv₂(category)=(cv₁*w+conversions₂(category))/(w+searches₂(category))

Determining baseline CTR metrics for merchant—level performance (i.e. with respect to queries that specify a particular manufacturer or retailer) can be determined in accordance with a number of embodiments of the invention using the following equation:

ctr₃(merchant)=(ctr₂(merchant)*w+clicks₃(merchant))/(w+searches₃(merchant))

where ctr₃(merchant) is a Bayesian estimate for merchant-level CTR, ctr₂(merchant) is the category level CTR estimate for the given merchant based on a weighted average of each ctr₂(category) where the merchant belongs to that category. A Bayesian estimate for category-level CV can be determined in accordance with embodiments of the invention by:

cv₃(merchant)=(cv₂(merchant)*w+conversions₃(merchant))/(w+searches₃(merchant))

The performance of the price adjustment when displayed in specific locations in the search results can be measured. The term page-level metrics can be used to describe the performance of price adjustment based on its page placement within the search results. The overall page-level metrics based on CTR can be determined in accordance with embodiments of the invention by the following equation:

ctr₁(page)=(ctr₁*w+clicks₁(page))/(w+searches₁(page))

where ctr₁(page) is a Bayesian CTR estimate for the given web pages across all categories, ctr₁ is determined as described above, clicks₁(page) is the total click count for the given web pages at the time of the calculation, and searches₁(page) is the total search count for the given web pages at the time of the calculation.

The overall page-level metrics based on CV can be determined in accordance with embodiments of the invention by the following equation:

cv₁(page)=(cv₁*w+conversions₁(page))/(w+searches₁(page))

The category page-level metrics (i.e. the page-metrics with respect to queries in which a particular category is specified) based on CTR can be determined in accordance with embodiments of the invention by the following equation:

ctr₂(category,page)=(ctr₂(category)*(ctr₁(page)/ctr₁)*w+clicks₂(category,page))/(w+searches₂(category,page))

where ctr₂(category,page) is the Bayesian category-level CTR estimate for the given web pages, ctr₂(category) is calculated as described above, ctr₁(page)/ctr₁ is the ratio between cv₁(page) and cv₁, and clicks₂(category,page) and searches₂(category,page) are the category-level clicks and searches for the given web pages at the time of the calculation.

The category page-level metrics based on CV can be determined in accordance with embodiments of the invention by the following equation:

cv₂(category,page)=(cv₂(category)*(cv₁(page)/*w+conversions₂(category,page))/(w+searches₂(category,page))

The merchant page-level metrics (i.e. the page-metrics with respect to queries in which a particular merchant is specified) based on CTR can be determined in accordance with embodiments of the invention by the following equation:

ctr₃(merchant,page)=(ctr₃(merchant)*(ctr₂(merchant,page)/ctr₂(merchant))*w+clicks₃(merchant,page))/(w+searches₃(merchant,page))

where ctr₃(merchant,page) is the Bayesian merchant-level CTR estimate for the given “page” and ctr₂(merchant,page) and ctr₂(merchant) are calculated as weighted averages from ctr₂(category,page) and ctr₂(category), based on merchant-category mapping/weights for the given merchant.

The merchant page-level metrics based on CV can be determined in accordance with embodiments of the invention by the following equation:

cv₃(merchant,page)=(cv₃(merchant)*(cv₂(merchant,page)/cv₂(merchant))*w+conversions₃(merchant,page))/(w+searches₃(merchant,page))

In a variety of embodiments, determining the relevancy of price adjustment data to a specific search query includes determining CTR and/or CV based on how recently the statistics utilized above were determined. The following formulas can be used to calculate the recency weighted average CTR and CV in accordance with embodiments of the invention:

searches_{rw}(t)=a*searches_{rw}(t−1)*b̂s(t)+s(t)

clicks_{rw}(t)=a*clicks_{rw}(t−1)*b̂s(t)+c(t)

conversions_{rw}(t)=a*conversions_{rw}(t−1)*b̂s(t)+v(t)

where searches_{rw}(t) is recency weighted searches after time t, clicks_{rw}(t) is recency weighted clicks after time t, conversions_{rw}(t) is recency weighted conversions after time t, s(t) is the observed number of searches on time t, c(t) is the observed number of clicks on time t, v(t) is the observed number of conversions on time t, a is the daily decay factor, and b is the decay factor per search.

Although specific processes for determining relevancy are described above, any of a variety of processes and techniques for determining the relevancy of price adjustment data to a specific search query can be utilized in accordance with embodiments of the invention. Processes for identifying products and price adjustments relevant to the products in accordance with embodiments of the invention are discussed further below.

### Retrieving Products Using Product Categories and Price Thresholds

In addition to price adjustments that are relevant to a specific search query, price adjustment location systems in accordance with embodiments of the invention can be configured to generate lists of relevant products for a consumer to browse along with identifying price adjustments for the located products. A flow chart illustrating a process for generating a list of products using a search query in accordance with an embodiment of the invention is shown in FIG. 4B. The process 450 includes receiving (460) a product query. A product category is determined (462). Relevant products are identified (464). Product prices are determined (466). In several embodiments, a product list is ranked (468) based on relevancy. The product list is then returned (470).

In many embodiments, a product query is received (460) from a consumer device. A product query can include a variety of information, including, but not limited to, the location of the consumer device, a user profile associated with the consumer device, a product category, and/or a price threshold. Other information can be included in a product query in accordance with the requirements of a variety of embodiments of the invention. In several embodiments, a product category is determined (462) using a local taxonomy and/or an external taxonomy retrieved from a retailer server system and/or a product information server system.

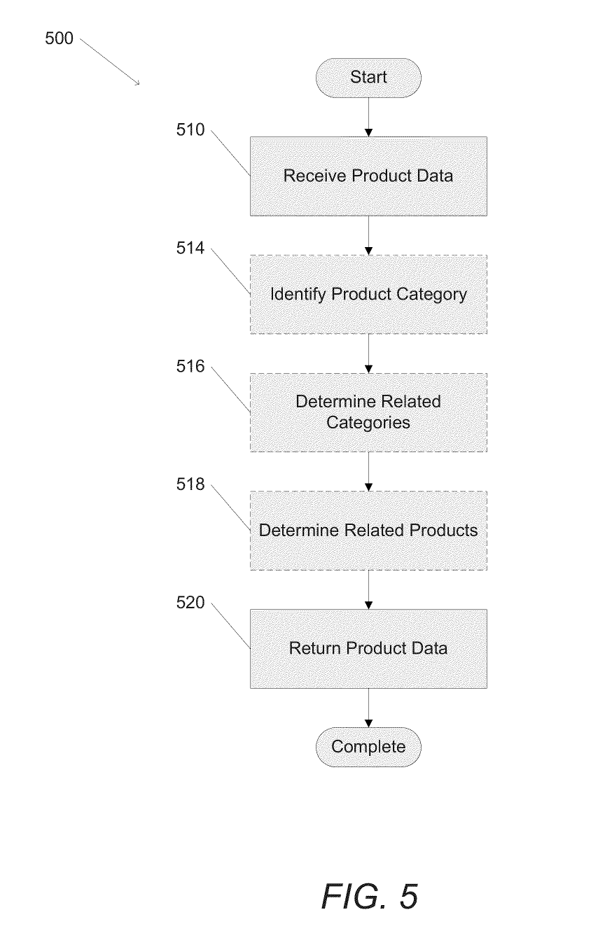

In a number of embodiments, relevant products are identified (464) utilizing the determined (462) product categories. In many embodiments, relevant products belong to the determined (462) product category in a taxonomy. In a number of embodiments, relevant products can be identified using the taxonomy and a set of predetermined rules concerning proximity of related products within the taxonomy. Processes for identify related products using a taxonomy are discussed further below with reference to FIG. 5. In several embodiments, identifying (464) relevant products includes determining if the price of the product net any price adjustments is within a threshold value of a price threshold in the received (460) product query; the threshold value can be predetermined and/or determined dynamically. In a variety of embodiments, relevant products are identified (464) utilizing one or more relevancy factors, including, but not limited to, retailer rating data associated with a retailer, user retailer rating data associated with a retailer, the number of different products provided by a retailer, product inventory maintained by the retailer, brand name strength data associated with a product, and the relevancy of the determined (462) product category or categories to the received (460) product query. In many embodiments, the relevancy factors can be weighted according to the requirements of a variety of embodiments of the invention.

In many embodiments, the price of a product is determined (466) using price data included in product metadata associated with the product and any applicable price adjustments that can be applied to the product. The determined (466) price of a product can vary between retailers offering the same product. In many embodiments, the relevant product data and associated product metadata, including product prices, are assembled into a product list. In a variety of embodiments, a product list further includes instructions for displaying the product list on a client machine. In a number of embodiments, the instructions for displaying the product list configure the client machine to generate a page displaying the product list, although a variety of instructions for displaying a product list can be utilized in accordance with embodiments of the invention. The discussion below refers to display of pages of information, however, it should be understood that information can be displayed using any of a variety of techniques appropriate to the requirements of a specific application. In many embodiments, ranking (468) a product list includes determining the click-through rate (CTR) and/or the conversion rate (CV) for product landing pages for each of the relevant products. The CTR and/or the CV can be determined based on the products purchased from the product listing and/or price adjustments utilized in the products purchased from the product list using any of the techniques outlined above.

Although specific processes for retrieving products using product categories and price thresholds in accordance with embodiments of the invention are described above with respect to FIG. 4B, any of a variety of processes for retrieving product data not specifically described can be utilized in accordance with embodiments of the invention. Methods for locating products and categories related to a particular product or category in accordance with embodiments of the invention are discussed further below.

Identifying Related Products using Taxonomies

Consumers who are interested in a particular product may be interested in similar products from other manufacturers and/or other products from the same manufacturer. Price adjustment location systems in accordance with many embodiments of the invention can be configured to present query results including products that are related to a specific product identified within a search query using relationships captured within a taxonomy. A variety of rules can be defined for determining the extent to which products are related based on the number of ancestor categories within the taxonomy that are shared by any two products and/or the distance within the taxonomy between two products. In addition, rules can be defined for specific categories within and/or products within a taxonomy that enable the identification of related products.

A flow chart illustrating a process for identifying categories and products related to a particular category or product is shown in FIG. 5. The process 500 includes receiving (510) product data. A category associated with the product data is identified (514). In several embodiments, related categories are determined (516) using one or more predetermined rules for identifying related categories. In many embodiments, related products are determined (518) based on the identified related categories and product data for related products is returned (520).

Although specific processes for identifying related products and categories to a particular product in accordance with embodiments of the invention are described above with respect to FIG. 5, any of a variety of processes for identifying related products and categories can be utilized in accordance with embodiments of the invention. For example, in many embodiments machine learning techniques can be utilized to provide a recommendation engine that recommends products that are likely to be of interest to a specific user and/or demographic of user. In other embodiments, any of a variety of prediction engines and/or recommendation engines can be utilized as appropriate to the requirements of a specific application. Methods for determining the price for a particular product in accordance with embodiments of the invention are discussed below.

### Determining Price Adjustments for Products

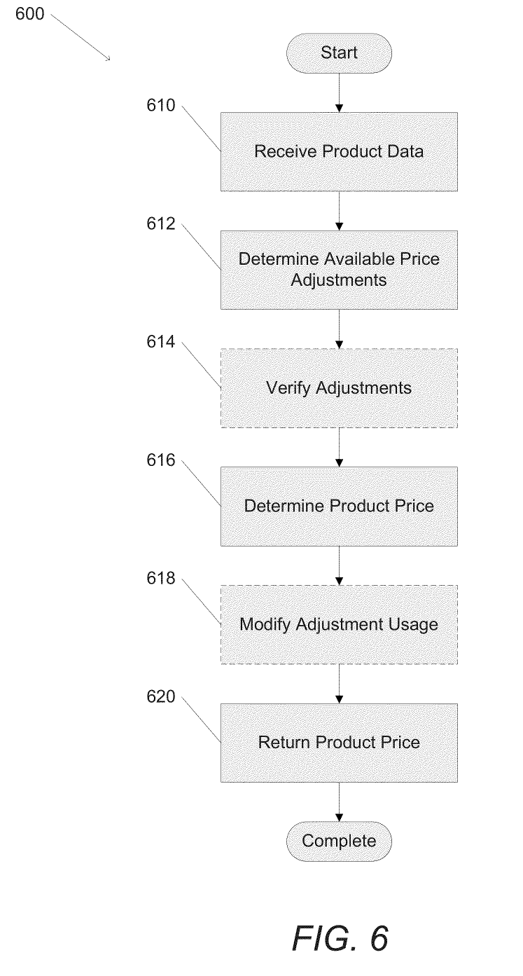

Consumers shopping for products are often motivated to locate a fair price for those products. Often, a retailer appearing to offer a product at a higher price than other retailers may in fact have the lowest price due to an available coupon or other price adjustment. Due to the large number of retailers available, it can be difficult for a consumer to locate these deals. Price adjustment location systems in accordance with embodiments are configured to locate price adjustments and display the adjusted price of spending a specified amount of money on an arbitrary product (factoring in any discounts, taxes, and/or shipping costs) or the adjusted cost of purchasing a specific product (factoring in any discounts, taxes, and/or shipping costs). A flow chart illustrating a process for computing the adjusted price for a product in accordance with an embodiment of the invention is shown in FIG. 6. The process 600 includes receiving (610) product data. Available price adjustments are determined (612). In a number of embodiments, the price adjustments are verified (614). The price of the product is determined (616). In several embodiments, price adjustment metadata associated with the price adjustment is modified (618). The adjusted price of the product can then be returned (620).

In a variety of embodiments, determining (612) available price adjustments includes retrieving price adjustment data based on a product identified by the product data and the categories within the taxonomy to which the product belongs. As discussed above, the process of scraping price adjustment information can involve associating price adjustments with specific categories and products within a taxonomy either directly or indirectly by associating specific manufacturers and retailers with categories and products within the taxonomy and then associating specific price adjustments with the appropriate manufacturer or retailer. Therefore, the category and product information for the product identified within the taxonomy can be utilized to identify price adjustments that are relevant to the product. In many embodiments, the retrieved price adjustment data includes the start and end date of the price adjustment, the value of the price adjustment, the type of the price adjustment, the products to which the price adjustment can be applied, and/or the retailers that will honor the price adjustment.

In a number of embodiments, verifying (614) price adjustments includes checking the start date and/or end date associated with the price adjustment with the current date. In many embodiments, verifying (614) a price adjustment includes querying the provider of the price adjustment to determine if one or more retailers and/or retailer server systems identified as honoring the price adjustment are still honoring the price adjustment. In a variety of embodiments, verifying (614) a price adjustment includes identifying, merging, and/or removing duplicate price adjustments.

In several embodiments, determining (616) the price of a product includes applying one or more price adjustments to the price of the product; the price of the product is contained in the product data (or product metadata) associated with the product. In a number of embodiments, the determined (616) price of the product includes estimated shipping costs and/or estimated tax to be assessed on the sale. In many embodiments, determining (616) the price of a product includes determining if the user spends more than the price of the product that another and/or an additional price adjustment could be applied. In a variety of embodiments, determining (616) the price of a product includes determining if a consumer must spend a minimum amount to apply a price adjustment to the product, e.g. the price adjustment is valid above a particular price threshold. Other processes for determining (616) the price of a product can be utilized in accordance with the requirements of a number of embodiments of the invention. In several embodiments, modifying (618) price adjustment metadata associated with the price adjustment includes determining and/or aggregating usage information related to the price adjustment, such as, but not limited to, the number of times the price adjustment is used to determine (616) the price of a product, the number of times a product to which the price adjustment applies has been purchased, the number of times a price adjustment has been redeemed, and the manufacturer(s) and/or retailer(s) who have honored the price adjustment. Other information can be included and/or modified (618) in the price adjustment metadata in accordance with a variety of embodiments of the invention. In several embodiments, returning (620) the adjusted price of the product includes generating product price metadata associated with the price adjustment data and/or the product data and returning the product price metadata. In a number of embodiments, returning (620) the price of the product includes modifying product metadata associated with product data and returning the product metadata.

Although specific processes for determining the adjusted price for a particular product in accordance with embodiments of the invention are described above with respect to FIG. 6, any of a variety of processes for determining the price of a product can be utilized in accordance with embodiments of the invention. Methods for locating products utilizing location information in accordance with embodiments of the invention are discussed further below.

### Location-Based Products and Price Adjustments

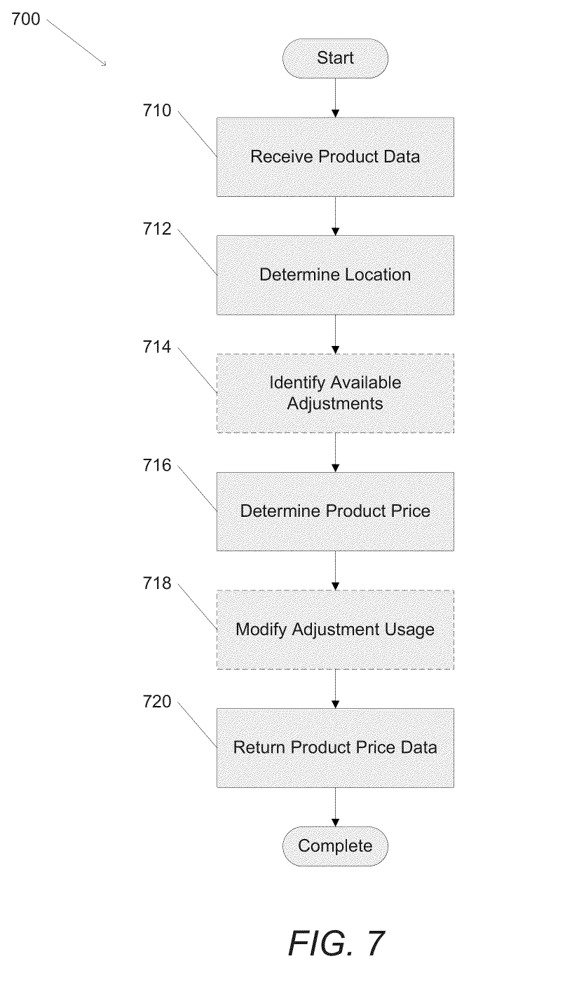

When a consumer shopping in a brick and mortar retailer locates a product he or she wishes to purchase, often the consumer will search for the product on the Internet to determine if an e-commerce retailer is offering the same product for a lower price than the price advertised by the brick and mortar retailer. In many embodiments, price adjustment location systems are configured to determine the location of a consumer searching for a particular product and provide price adjustments to the consumer based on the location of the user. In this way, retailers that are close to the user's current location can offer location based price adjustments. A flow chart illustrating a process for providing location based price adjustments utilizing location information is shown in FIG. 7. The process 700 includes receiving (710) a query that may include product data and/or identify a category. Retailers that are proximate the user's location and that stock the relevant product(s) are determined (712). In a variety of embodiments, available adjustments are identified (714) with respect to the relevant products. In many embodiments, the price adjustments may include location independent price adjustments and location specific price adjustments that are accessible due to the user's location. The price of the product is determined (716). In many embodiments, the usage data associated with the price adjustment is modified (718) and product location and adjusted pricing data is returned (720).

In a variety of embodiments, the received (710) product data is included in a search query. In many embodiments, the received (710) product data is selected from a product listing. In a number of embodiments, the location of the product is determined (712) using the location of the device providing the search query and/or product listing selection. In several embodiments, the location of the product is determined (712) using product metadata associated with the received (710) product data. In a variety of embodiments, available adjustments are identified (714) utilizing a process similar to the one described above with respect to FIG. 6. In many embodiments, the price of the product is determined (716) utilizing product metadata associated with the product and one or more available adjustments.

Specific processes for providing location-based price adjustments in accordance with embodiments of the invention are described above with respect to FIG. 7; however, any of a variety of processes for performing location-based price adjustments not specifically described can be utilized in accordance with embodiments of the invention. For example, the price adjustment location system can provide a manufacturer and/or retailer with an indication that a user is looking for a price adjustment with respect to a specific category and/or product and the manufacturer and/or retailer can dynamically generate a price adjustment to offer the user in an attempt to influence the user to purchase the goods from them.

Although the present invention has been described in certain specific aspects, many additional modifications and variations would be apparent to those skilled in the art. For example, any of the various processes described above can be performed in alternative sequences and/or in parallel (on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A product location system, comprising:
a processor; and
memory;
wherein the memory is configured to store a price adjustment location application; and
wherein the price adjustment location application configures the processor to:
obtain a search query, where the search query comprises product budget data identifying at least one product price threshold;
determine at least one product category based on the obtained search query, where a product category describes a grouping of products;
identify at least one price adjustment based on the determined at least one product category and the product budget data, where the at least one relevant price adjustment falls within a specified budget based on the at least one product price threshold; and
generate a listing of relevant price adjustments based on the identified price adjustments.

2. The product location system of claim 1, wherein:
the search query is obtained from a client machine; and
the price adjustment location application further configures the processor to transmit the generated listing of relevant price adjustments to the client machine.

3. The product location system of claim 2, wherein the generated listing of relevant price adjustments further comprises instructions that configure the client machine to generate a page displaying the product list.

4. The product location system of claim 1, wherein:
the search query further comprises product category data identifying at least one requested product category; and
determining the at least one product category is based on the product category data contained in the search query.

5. The product location system of claim 4, wherein:
the price adjustment location application further configures the processor to determine the at least one product category based on the search query using a master taxonomy; and
the master taxonomy comprises a set of categories, a set of products, a set of price adjustments, and a set of relationships between the categories, products, and price adjustments, where the relationships represent classifications of the products, categories, and price adjustments.

6. The product location system of claim 5, wherein:
at least one category and at least one product described within the master taxonomy comprise at least one keyword component; and
the price adjustment location application further configures the processor to map keywords components into the master taxonomy, where the mapped keyword components describe the relationships between the categories and products described within the master taxonomy.

7. The product location system of claim 6, wherein the price adjustment location application further configures the processor to:
obtain a retailer taxonomy comprising keyword components describing the categories and products available from a retailer server system; and
map the obtained retailer taxonomy into the master taxonomy based on the keyword components contained within the obtained retailer taxonomy.

8. The product location system of claim 7, wherein the price adjustment location application further configures the processor to filter the master taxonomy, where filtering the master taxonomy comprises removing at least one piece of product data from the master taxonomy.

9. The product location system of claim 1, wherein the price adjustment location application further configures the processor to sort the listing of price adjustments based on the relevancy of the identified price adjustments.

10. The product location system of claim 9, wherein:
the price adjustments comprise price adjustment metadata describing the click-through rate associated with the price adjustments; and
the price adjustment location application further configures the processor to determine the relevancy of price adjustments based on the click-through rate of the price adjustments.

11. The product location system of claim 10, wherein the price adjustment location application further configures the processor to weight the relevancy of price adjustments based on the recency of the click-through rate described in the price adjustment metadata associated with the price adjustments.

12. The product location system of claim 9, wherein:
the price adjustments comprise price adjustment metadata describing the conversion rate associated with the price adjustments; and
the price adjustment location application further configures the processor to determine the relevancy of price adjustments based on the conversion rate described in the price adjustment metadata.

13. The product location system of claim 1, wherein:
the search query further comprises product data identifying at least one product; and
the price adjustment location application further configures the processor to:
determine at least one product category based on the product data;
identify at least one piece of product data based on the determined at least one product category, where a piece of product data comprises product metadata describing price data associated with the product data;
determine product price data based on the identified pieces of product data and the relevant price adjustments; and
generate a product list comprising the at least one piece of product data and the associated product price data.

14. The product location system of claim 13, wherein the price adjustment location application further configures the processor to rank the product list based on the relevancy of the products data contained in the product list.

15. The product location system of claim 1, wherein:
the search query comprises location information; and
the price adjustment location application further configures the processor to:
identify at least one piece of product data based on the location information, where the product data comprises product metadata including product location information describing the physical location of the product described by the product data;
determine product price data for the at least one piece of product data; and
return the determine product price data.

16. The product location system of claim 15, wherein the location information for a piece of product data comprises the location of a retailer selling a product described by the piece of product data.

17. The product location system of claim 16, wherein the price adjustment location application further configures the processor to identify available price adjustments that are valid for the retailer selling the product described by the piece of product data.

18. The product location system of claim 17, wherein the price adjustment location application further configures the processor to generate a price adjustment based on the product data and the obtained search query, where the generated price adjustment is valid at a retailer located proximate to the location data.

19. The product location system of claim 15, wherein:
the search query is obtained from a consumer device; and
the location information in the search query describes the physical location of the consumer device captured using location-determination capabilities of the mobile device.

20. The product location system of claim 1, wherein the price adjustment location application further configures the processor to transmit the generated listing of relevant price adjustments to a consumer device.

21. The product location system of claim 1, wherein:
the search query further comprises user profile information describing tracked user behaviors with respect to the product location system; and
the price adjustment location application further configures the processor to identify at least one price adjustment based on the user profile information.

22. A method for generating a list of price adjustments, comprising:
obtaining a search query using a product location system, where the search query comprises product budget data identifying at least one product price threshold;
determining at least one product category based on the obtained search query using the product location system;
identifying at least one relevant price adjustment based on the determined product category and the product budget data using the product location system, where the at least one relevant price adjustment falls within a specified budget based on the at least one product price threshold; and
generating a listing of relevant price adjustments based on the identified relevant price adjustments using the product location system.
